(19) United States
(12) Patent Application Publication
(10) Pub. No.: US 2022/0220225 A1
(43) Pub. Date: Jul. 14, 2022

(54) A method of treating a cellulosic material, a method of preparing a hydrolysed cellulosic material, use of a chlorite salt and gaseous pressurized HCl, use of chlorous acid, and a hydrolysed cellulosic material

(71) Applicant: Aalto University Foundation sr, Aalto (FI)

(72) Inventors: Timo Pääkkönen, Aalto (FI); Eero Kontturi, Aalto (FI)

(21) Appl. No.: 17/610,170

(22) PCT Filed: May 8, 2020
(86) PCT No.: PCT/FI2020/050314

§ 371 Date: Nov. 10, 2021

(30) Foreign Application Priority Data
May 10, 2019 (FI) 20195393

(51) Int. Cl. C08B 15/04; D21C 9/00; D21C 9/14

(52) U.S. Cl. CPC C08B 15/04; D21C 9/14; D21C 9/004

(57) ABSTRACT

According to an example aspect of the present invention, there is provided a method of treating, such as hydrolysing, a cellulosic material, comprising: preparing a mixture comprising or consisting of a cellulosic material and a chlorite containing water solution, such as a chlorite salt containing water solution; acidifying said mixture.

### FIELD

The present invention relates to manufacturing of cellulosic nanomaterials, and more particularly to acid hydrolysis methods of cellulosic materials.

### BACKGROUND

Cellulosic nanomaterials, such as microcrystalline cellulose (MCC) cellulose nanocrystals (CNCs) and cellulose nanofibrils, constitute an important category of renewable nanomaterials. Various plant-based cellulosic materials can be used as raw materials for the manufacturing of CNCs and cellulose nanofibrils. The manufacturing process comprises an acid hydrolysis step and a mechanical grinding or dispersion step.

In the acid hydrolysis step, sulphuric acid is typically utilized. A number of problems arise from the use of sulphuric acid: the end product is difficult to purify, water consumption is high and yields are low. The end product exhibits sulphate groups, which positively contribute to dispersibility of the hydrolysed product.

Additionally, virtually all conventional acid hydrolysis techniques of cellulose are based on a heterogeneous system of liquid acid and solid fibers. For MCC, moderately high concentrations (for example 2 M) of aqueous HCl are typically applied. For CNC, concentrated aqueous H₂SO₄ (for example 65%) is generally being used. In both cases, the result of the hydrolysis is a mixture of the desired product (MCC or CNC), sugars, acid, and water. Consequently, the purification of the product is rather difficult and full recovery of the acid is not feasible. Other challenges include low yield, and high water consumption.

Hydrochloric acid gas and formic acid have been recently experimented as alternatives to sulphuric acid in the context of bacterial cellulosic materials, but so far the applicability of these acids has been limited due to difficulties in end product dispersibility and in extensive reaction times needed (see Pääkkönen 2016 and Kontturi 2018).

A further problem in the case of high moisture content cellulosic materials (such as materials with a dry matter content less than 80%) and/or lignin-containing cellulosic materials is the formation of coloured compounds during the hydrolysis reaction.

The present invention is intended to overcome at least some of the disadvantages in the known methods for the manufacturing of cellulosic nanomaterials.

### SUMMARY OF THE INVENTION

The invention is defined by the features of the independent claims. Some specific embodiments are defined in the dependent claims.

According to a first aspect of the present invention, there is provided a method of treating, such as hydrolysing, a cellulosic material, comprising: preparing a mixture comprising or consisting of a cellulosic material and a chlorite containing water solution, such as a chlorite salt containing water solution; acidifying said mixture.

Various embodiments of the first aspect may comprise at least one feature from the following bulleted list:
The cellulosic material is a lignocellulosic fibrous material, such as unbleached wood pulp, for example unbleached kraft pulp.
The cellulosic material comprises plant-based pulp, for example wood pulp or potato pulp.
The dry matter content of the cellulosic material, before adding the chlorite salt, is less than 80%; the chlorite salt is added as an aqueous solution; the added chlorite solution and the cellulosic material are mixed to obtain a dispersion, preferably a substantially homogeneous or a thoroughly mixed dispersion; in the mixture to be acidified, the concentration of the chlorite salt is at least 0.5%.
The cellulosic starting material is a lignin-containing cellulosic material that preferably comprises at least 5% lignin, preferably at least 19.3% lignin.
The chlorite salt is an aqueous solution of NaClO₂.
The concentration of the chlorite salt, preferably NaClO₂, during said acidifying step is at least 0.1%.
The concentration of the chlorite salt, preferably NaClO₂, during said acidifying step is at least 0.5%, preferably 0.5 to 13.4%, such as 0.5 to 3.99%.
Said acidifying is carried out by bringing said aqueous mixture in contact with a gaseous pressurized strong acid; and whereby the pH becomes lowered to below 0.5.
Said acidifying is carried out by bringing said aqueous mixture in contact with a gaseous pressurized hydrogen halide, preferably gaseous pure HCl.
The gas pressure during said acidifying step is at least 0.1 bar, such as at least 1 bar, for example in the range 1 to 2 bar.
The gaseous strong gas is added to the mixture periodically to keep the pressure above 1 bar.
The temperature during said acidifying step is 10 to 100° C.
The method comprises: providing a dispersion of pulp, preferably chemical wood-based pulp; providing a chlorite solution; mixing said pulp dispersion and said chlorite solution thoroughly; acidifying said mixture.

According to a second aspect of the present invention, there is provided a method of preparing a hydrolysed cellulosic material, comprising: providing a high moisture content cellulosic raw material comprising at least 20% water; producing chlorous acid in said cellulosic raw material; allowing said cellulosic raw material and said chlorous acid to react with each other; and as a result, obtaining a hydrolysed cellulosic material.

Various embodiments of the second aspect may comprise at least one feature from the following bulleted list:
Said producing step comprises: adding NaClO₂ to said cellulosic raw material and mixing thoroughly; acidifying the mixture of said cellulosic raw material and said NaClO₂ by pressurized HCl gas; and as a result, producing chlorous acid from NaClO₂ in the acidic conditions.
NaClO₂ is added to provide a concentration of 0.5 to 13.4%, more preferably 3.3 to 13.4%; and the applied gas pressure is at least 1 bar.

According to a third aspect of the present invention, there is provided use of a chlorite salt and gaseous pressurized HCl for simultaneous hydrolysis and bleaching of a cellulosic material, preferably a lignocellulosic material.

According to a fourth aspect of the present invention, there is provided use of chlorous acid for hydrolysis of a high moisture content cellulosic material comprising at least 20% water.

According to a fifth aspect of the present invention, there is provided a hydrolysed cellulosic material obtained by an acid hydrolysis method with chlorous acid, which hydrolysed cellulosic material preferably comprises less than 5% humin compounds.

According to a sixth aspect of the present invention, there is provided a hydrolysed cellulosic material obtained by the method according to the second aspect.

Various embodiments of the fifth or sixth aspect may comprise at least one feature from the following bulleted list:
The hydrolysed cellulosic material is a plant-based cellulosic material, preferably a wood-based cellulosic material.
The hydrolysed cellulosic material comprises less than 1% humin compounds, preferably the hydrolysed cellulosic material is substantially free from humin compounds.
The hydrolysed cellulosic material is obtained from unbleached kraft pulp, wherein the kappa number of the hydrolysed cellulosic material is less 50, preferably less than 30.
The degree of polymerisation of the hydrolysed cellulosic material is less than 800, preferably less than 300.
The ISO brightness of the hydrolysed cellulosic material is at least 50, preferably 60 to 100.

According to a seventh aspect of the present invention, there is provided use of the hydrolysed cellulosic material according to the fifth or sixth aspect.

Advantages

The present invention provides a number of advantages in relation to the known hydrolysis methods that are based on heterogeneous liquid/solid systems.

An important advantage of the present method is that colour formation, particularly due to formation of humins, during hydrolysis of cellulosic materials may be avoided.

Further, higher yields may be achieved.

An advantage of the present invention is that the method may be applied for simultaneous bleaching and hydrolysis of cellulosic materials.

The present invention enables decreasing water consumption and recycling of the reaction products in the manufacturing of cellulosic nanomaterials, particularly the acid used in the hydrolysis. Purification of the end product, hydrolysed cellulose, may be facilitated.

An advantage of some embodiments of the present invention is that the hydrolysed end product remains underivatized, such as not functionalized by sulphate groups. The hydrolysed product may be later derivatized or functionalized if need be, for example by adding carboxylate groups via a TEMPO oxidation process.

The present invention is advantageous in hydrolysis of high moisture content (>20%) cellulosic materials and/or lignin containing cellulosic materials. It may also be used for hydrolysis of low moisture content (<5%) cellulosic materials.

### BRIEF DESCRIPTION OF THE DRAWINGS

FIG. 1 is a schematic illustration of an apparatus for hydrolysis in accordance with an embodiment of the present invention.

FIG. 2 shows a graph of ISO brightness of the product as a function of NaClO₂ concentration during hydrolysis in an embodiment of the present invention.

FIG. 3 shows a graph of Kappa number of the product as a function of NaClO₂ concentration during hydrolysis in an embodiment of the present invention.

FIG. 4 shows a graph of ISO brightness of the product as a function of NaClO₂ concentration during hydrolysis in an embodiment of the present invention.

FIG. 5 shows a graph of degree of polymerisation (DP) of the product as a function of NaClO₂ concentration during hydrolysis in an embodiment of the present invention.

FIG. 6 is a SEM micrograph of the product according to an embodiment of the present invention.

FIG. 7 is a SEM micrograph of the product according to an embodiment of the present invention.

FIG. 8 shows AFM micrographs of the product according to an embodiment of the present invention.

FIG. 9 is an AFM micrograph of the product according to an embodiment of the present invention.

FIGS. 10(a) to 10(d) show AFM micrographs of the product according to an embodiment of the present invention.

FIG. 11 shows schematically a process for manufacturing CNCs according to an embodiment of the present invention.

### EMBODIMENTS

In the present text, all percent values are in units percent from the weight of the whole composition or mixture, unless something else is indicated.

We have observed that an effective hydrolysis of a cellulosic material can be achieved by treating the cellulosic material with a chlorite salt in acidic conditions. Advantageously, simultaneous bleaching of the cellulosic material may be achieved.

In some embodiments, the invention relates to combined acid hydrolysis and bleaching of a cellulosic material with pressurized HCl gas and a chlorite salt.

In some embodiments, a chlorite salt is mixed with a cellulosic material and thereafter acidic conditions are provided by bringing a gaseous acid in contact with the mixture.

In preferred embodiments, the present invention provides an acid hydrolysis method that is based on a hydrolysis reaction between a solid cellulosic material and a gaseous acid, preferably HCl gas.

The use of gaseous acid is advantageous. The gas mixture can be efficiently recovered in the process because separation of gas and solid is far simpler than separation of liquid and solid. Most of the gas may be removed with airflow after the hydrolysis. Additionally, moderate amounts of washing water may be used to remove gas residuals and dissolved components (such as hemicelluloses, lignin etc.).

According to the invention, typical yields of the hydrolysis process are higher than 70%.

Advantageously, the obtained product is typically purified with the process (thus resulting in higher concentrations of cellulose) and also bleached and delignified (resulting in higher brightness).

We have observed that the product resulting from the present hydrolysis method can be effortlessly purified for example by hot water extraction.

In one embodiment, chlorite is added to the cellulosic material by moistening or dispersing the sample in a chlorite-containing water solution.

It is believed that the use of chlorite halts the undesired formation of humins. Humins usually plague extended cellulose hydrolysis by discolouration even at minute concentrations. In the present invention, the oxidation of humin precursors (furfural and 5-hydroxymethylfurfural (HMF)) with chlorite halts effectively the formation of humins.

A humin can be defined as a furanic structure with alcohol, acid, ketone and aldehyde functional groups which is formed via a dehydration pathway, see for example Zandvoort 2015.

In some embodiments, chlorous acid (HClO₂) is formed to the reaction mixture from sodium chlorite (NaClO₂) at acidic conditions. The chlorous acid can oxidize aldehydes, such as aldehydic humin precursors, to carboxylic acids.

Moreover, the formation of chlorine dioxide (ClO₂) from chlorite enables delignification or bleaching of lignin-containing cellulosic material (such as unbleached kraft pulp) in the same process step.

Thus, in some embodiments, the addition of NaClO₂ and acidification prevents the undesired colour formation and enables the bleaching of coloured pulps along with cellulose hydrolysis, which preferably is carried out with pressurized HCl gas.

The hydrolysed product may be used for the preparation of for example, microcrystalline cellulose or cellulose nanocrystals.

In one embodiment, pressurized HCl gas can be applied to hydrolysis of cellulose as part of cellulose nanocrystal (CNC) and microcrystalline cellulose (MCC) production.

Gases used and/or formed in the reaction mixture (such as HCl and ClO₂ from chlorite) may be easily recovered from the reactor.

In one embodiment, the cellulosic starting material is a wood-based cellulosic material.

In one embodiment, the cellulosic starting material is a cellulosic material comprising lignin, such as at least 19.3% lignin.

In one embodiment, the cellulosic starting material comprises or consists of a wood-based cellulosic material comprising lignin.

In one embodiment, the cellulosic starting material comprises of consists of wood pulp, for example kraft pulp. Preferably, the wood pulp is unbleached.

In one embodiment, the cellulosic starting material comprises or consists of dissolving pulp.

In one embodiment, the cellulosic starting material is in the form of particles, fibers and/or sheets.

In one embodiment, the cellulosic starting material is in the form of particles preferably having a sieved size smaller than 1 mm.

In one embodiment, the cellulosic starting material is in the form of fibers preferably having a diameter smaller than 1 mm.

In one embodiment, the cellulosic starting material is in the form of a sheet or web, in which preferably at least one dimension is smaller than 1 mm.

In one embodiment, the chlorite salt is selected from the following group: alkali metal chlorites, alkaline earth metal chlorites.

Preferably, the chlorite salt is sodium chlorite or potassium chlorite or lithium chlorite, most preferably sodium chlorite.

In a preferred embodiment, the cellulosic starting material is first mixed with an aqueous solution or dispersion or paste comprising a chlorite salt. After the mixing, the dry matter content of the mixture is optionally increased for example by pressing. Thereafter, the mixture is acidified.

In some embodiments, chlorous acid (HClO₂) is produced in a dispersion comprising a cellulosic material, preferably in situ. Chlorous acid may be produced from a chlorite salt in acidic conditions via for example the following reaction in which HCl is used as the acid:

NaClO₂+HCl→HClO₂+NaCl

In some embodiments, chlorine dioxide (ClO₂) is also produced in the dispersion comprising a cellulosic material, preferably in situ. Chlorine dioxide may be produced via for example the following reactions:

HClO₂+Cl⁻+H⁺→2HOCl

HClO₂+HOCl→Cl₂O₂+H₂O

Cl₂O₂+ClO₂⁻→2ClO₂+Cl⁻

The acidification is preferably carried out by adding a strong acid in a pressurized gaseous form.

The acidification is preferably carried out by adding a strong acid that is gaseous in room temperature.

For example, the acidification step is carried out by bringing a gaseous strong acid to the mixture comprising the cellulosic material and the chlorite salt. Preferably the gaseous strong acid is one of the following: HCl, HBr, HI. Most preferably the strong acid is HCl in a gaseous form.

In one embodiment, pure HCl gas is used for the acidification.

In another embodiment, HCl vapour is used for the acidification.

The hydrolysis reaction takes place in the acidified reaction mixture.

During the hydrolysis, the pH is preferably below 2, such as below 1, for example below 0.5.

During the hydrolysis, the temperature is preferably in the range 10 to 100° C., such as 10 to 30° C.

Preferably, the reaction mixture is not heated during the hydrolysis. For example, in the beginning of the hydrolysis, the temperature of reaction mixture is in the range 15 to 25° C.

During the hydrolysis, the gas pressure is preferably in the range 0.1 to 40 bar, such as 0.1 to 5 bar, for example 0.1 to 2 bar. Most preferably, the gas pressure is at least 1 bar, for example 1 to 2 bar.

The hydrolysis reaction is preferably allowed to proceed for 2 to 1200 minutes, for example at least 60 minutes.

The present invention is advantageous in hydrolysis conditions in which moisture content of the reaction mixture is high, such as at least 20%.

In some embodiments, the dry matter content of the reaction mixture (comprising the cellulosic starting material and the aqueous chlorite salt) during the hydrolysis step is less than 80%, for example 10 to 80%, preferably 10 to 30% from the weight of the whole mixture.

In some embodiments, the moisture content of the reaction mixture during the hydrolysis step is at least 10%, preferably at least 20%, more preferably at least 50%.

Exemplary parameters for NaClO₂/HCl gas hydrolysis according to the invention are 10-100° C. reaction temperature, 0.1 to 16% NaClO₂ addition, 2 to 1200 min reaction time, 0.1 to 2 bar gas pressure, and 10 to 98% dry matter content of cellulosic raw material.

In one embodiment, the cellulosic starting material comprises dissolving pulp. Preferably, the dry matter content during the hydrolysis is at most 23%. Preferably, the concentration of the chlorite salt during the hydrolysis is up to 3.99%, for example in the range 0.5 to 3.99%.

In one embodiment, the cellulosic starting material comprises unbleached high-lignin-content wood pulp comprising at least 19.3% lignin. Preferably, the dry matter content during the hydrolysis is at most 23%. Preferably, the concentration of the chlorite salt during the hydrolysis is up to 13.4%, for example in the range 0.5 to 13.4%, such as 3.3 to 13.4%. This embodiment benefits from the advantage that formation of coloured compounds may be effectively inhibited.

In one embodiment, the cellulosic starting material comprises potato pulp. Preferably, the dry matter content during the hydrolysis is up to 16%. Preferably, the concentration of the chlorite salt during the hydrolysis is up to 3.5%, for example in the range 0.5 to 3.5%. This embodiment provides the advantage of being able to utilize waste materials from agriculture, such as potato pulp.

In one embodiment, the cellulosic starting material comprises a high moisture content plant-based pulp. Preferably, the dry matter content during the hydrolysis is at most 80%, more preferably at most 30%. Preferably, the concentration of the chlorite salt during the hydrolysis is up to 16%, for example in the range 0.5 to 13.4%. The high moisture content cellulosic materials are interesting due to the exceptionally high hydrolysis rate of cellulose achievable in such conditions.

After the hydrolysis, one or more of the following optional steps may be carried out: hot water extraction, fluidization, sonication, dispersing, grinding, mincing, ball milling.

In one embodiment, the present invention provides a hydrolysed cellulosic material obtained by an acid hydrolysis method with chlorous acid, which hydrolysed cellulosic material comprises less than 5%, preferably less than 1% humin compounds.

In one embodiment, the hydrolysed cellulosic material is a plant-based cellulosic material, preferably a wood-based cellulosic material.

In one embodiment, the hydrolysed cellulosic material is substantially free from humin compounds. Preferably, the kappa number of the hydrolysed cellulosic material is then less than 30.

In some embodiments, the kappa number of the hydrolysed cellulosic material is less 50, preferably less than 30.

In one embodiment, the degree of polymerisation of the hydrolysed cellulosic material is less than 800, preferably less than 300. For a wood-based hydrolysed cellulosic material, DP is preferably less than 300. For a potato-based hydrolysed cellulosic material, DP is preferably less than 800.

In one embodiment, the ISO brightness of the hydrolysed cellulosic material is at least 50, such as 60 to 100.

Cellulosic nanomaterials, such as CNCs, can be prepared from the obtained hydrolysed cellulosic material for example by the following methods:

In one embodiment, the hydrolysed cellulosic material is further treated by TEMPO-mediated oxidation, which provides carboxylate functionalities to the cellulosic material. After the oxidation, the material may be purified, for example by centrifugation, and finally dispersed, for example by sonication or fluidization. As a result, CNCs are obtained.

“TEMPO oxidation” or “TEMPO-mediated oxidation” refers here to oxidation catalysed by N-oxoammonium cation of 2,2,6,6-tetramethylpiperidine-1-oxyl (TEMPO).

In one embodiment, the hydrolysed cellulosic material is oxidized and functionalized with carboxylate groups. Subsequently the material is dispersed, preferably by fluidization, whereby CNCs are obtained.

### EXAMPLES

In the following we describe experiments carried out according to some embodiments of the invention.

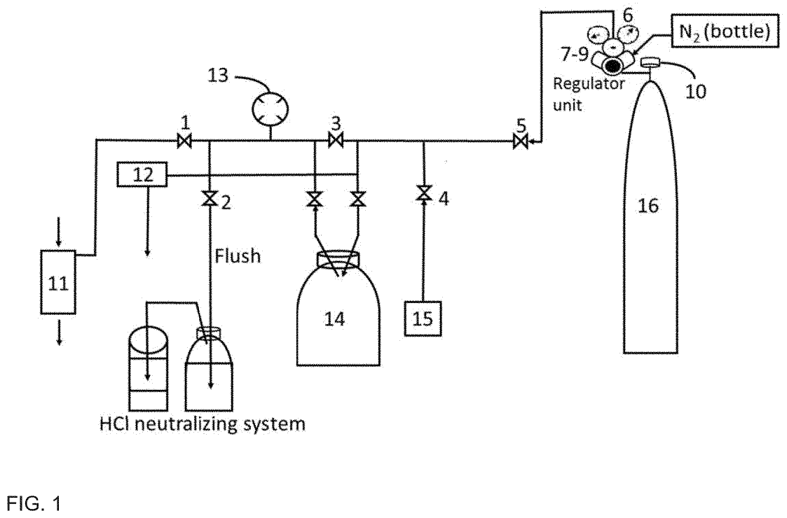

An exemplary apparatus for the hydrolysis reaction is shown in FIG. 1.

FIG. 1 shows a schematic picture of a cellulose degradation system with HCl gas (see Pääkkönen et al. 2018 for a more detailed description of the system).

FIG. 1 shows: Solenoid valves include vacuum valve 1, flush line valve 2, bypass valve 3, compressed air valve 4, HCl gas valve 5. Control valves 6 to 9 are applied to adjust HCl gas pressure and to control N₂ gas flow (applied to flush the gas regulator unit). The HCl gas bottle main valve is denoted as 10. The system also comprises vacuum inducing means 11, gas release valve 12, pressure transmitter 13, HCl neutralizing system, sample reactor 14, compressed air supply 15, and HCl bottle 16.

HCl gas 16 is added at a default pressure to the glass bottle (Duran pressure plus bottle (−1-1.5 bar), Sigma Aldrich) which can be referred to as the sample reactor 14. Default HCl gas pressure was acquired with degassing process, i.e., releasing air/HCl mixture to the flush line after HCl addition prior to the repeating HCl gas addition. Alternatively, vacuum in the sample reactor can be induced 11 prior to the HCl gas addition. The sample bottle was detached after the HCl addition. NSH coupling valves (Colder Products Company, USA) were applied for fast detachment/attachment and to ensure the preservation of the gas pressure in the sample reactor. Compressed air 15 and nitrogen gas were used to thoroughly flush the gas lines (PTFE) after HCl gas addition. The HCl gas was eventually neutralized by a system consisting of two alkaline solution containers (the first container being closed). Sirai D105V31 (Asco Numatics Sirai SR1, Italy) dry solenoid valves (body material—PVDF, denoted with reference signs 1 to 5) were applied to control the gas flows. The gas release valve 12 is a safety measure which releases the gas pressure at 4 bar in case the regulator membrane breaks down.

### Example 1: Dissolving Pulp

In this example we used a totally delignified dissolving pulp as the cellulosic starting material.

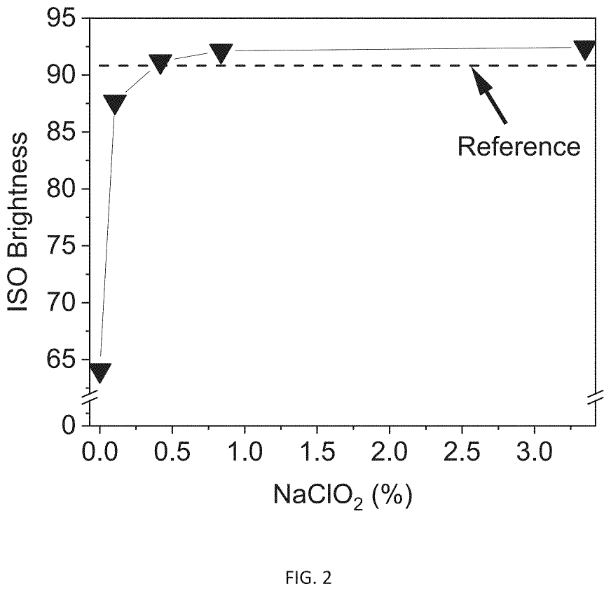

The hydrolysis of totally delignified dissolving pulp samples was conducted with a reaction time of 0.5 h, high moisture content (76%), and HCl gas pressure of 1 bar with variable additions of NaClO₂. The hydrolysis was started in room temperature and no external heating was applied during the course of the hydrolysis reaction. It was observed that colour formation of the hydrolysed cellulose can be blocked approximately with 0.5% addition of NaClO₂ (see FIG. 2).

FIG. 2 shows ISO brightness as a function of NaClO₂ addition with the HCl gas hydrolysis of dissolved pulp.

In the following we give a more detailed description of the experiments carried out in Example 1:

The dissolving pulp was mixed thoroughly with a chlorite containing water solution (0 to 4% NaClO₂ in 0.6 dm³ of water) and pressed to the desired dry matter content (23% dry matter, i.e. 76% moisture content). The chlorite containing pulp (35 g as dry, comprising or consisting of 0 to 3.99% NaClO₂) was added to the glass reactor. 1 bar gas pressure was introduced to the reactor. Excess gas was removed after the hydrolysis (which lasted for 0.5 h) to the neutralising alkaline container with air flow. Pulp was removed from the reactor and washed twice with pure water (2×2 dm³). Yields (70 to 86%) were determined prior to the more detailed analysing of the pulp samples. The degree of polymerisation (DP) of the raw material was 1253 and it decreased to 562 (3.99% NaClO₂ in pulp) and even lower without added chlorite (198).

### Example 2: High Lignin Content Wood Pulp

In this example we used unbleached high-lignin-content wood pulp as the cellulosic starting material.

We hydrolysed (pressurised HCl gas hydrolysis) high lignin content pulps (lignin content 19.3%) with variable additions of NaClO₂ to test delignification coupled with blocking of humin formation with unbleached pulps. Also here the hydrolysis was started in room temperature and no external heating was applied during the course of the hydrolysis reaction. Moreover, we studied the bleaching effect of NaClO₂ addition.

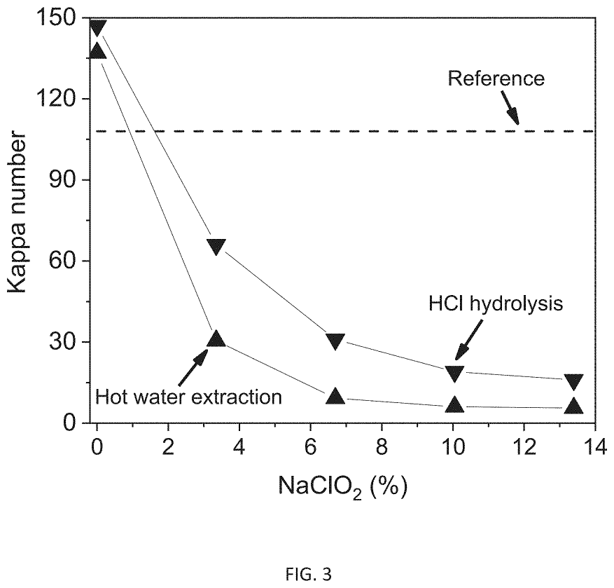

Both humins and lignin can be detected with kappa number titration. Kappa number analysis of hydrolysed samples without addition of chlorite resulted in higher kappa number values than the control reference sample (see FIG. 3). However, the kappa number reduced as a function of NaClO₂ addition.

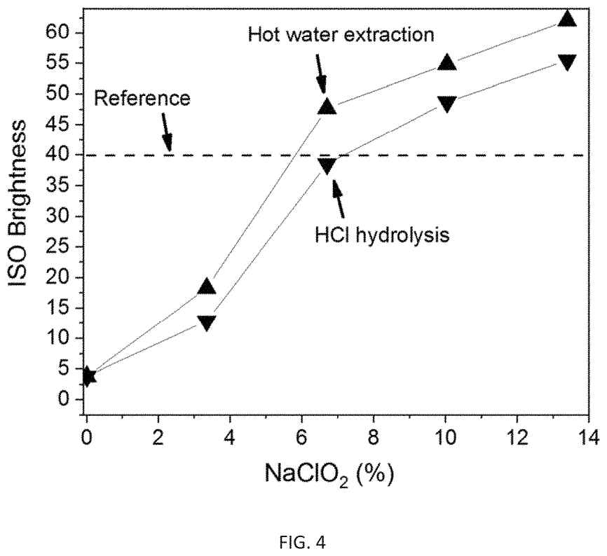

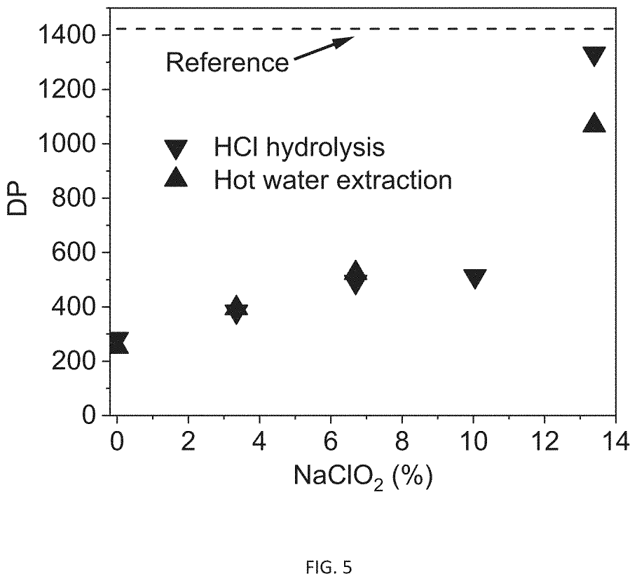

Subsequently, hot water extraction was applied after the hydrolysis to purify the samples, which were analysed accordingly. ISO brightness increased as a function of NaClO₂ addition (see FIG. 4). The reduction of DP was also analysed (see FIG. 5).

FIG. 3 shows Kappa number analyses of HCl gas/chlorite hydrolysed unbleached cellulosic samples. All samples were analysed after HCl hydrolysis and later after hot water extraction.

FIG. 4 shows ISO brightness analyses of HCl gas/chlorite hydrolysed unbleached cellulosic samples. All samples were analysed after HCl hydrolysis and later after hot water extraction.

FIG. 5 shows DP analyses of HCl gas/chlorite hydrolysed cellulosic samples. All samples were analysed after HCl hydrolysis and later after hot water extraction.

In the following we give a more detailed description of the experiments carried out in Example 2.

Pulp was mixed thoroughly with a chlorite containing water solution (0 to 16% NaClO₂ in 0.6 dm³ of water). Pulp was pressed to the dry matter content of 23% (comprising or consisting of 0 to 13.4% NaClO₂). The chlorite containing pulp (35 g as dry) was added to the glass reactor. 1 bar HCl gas pressure was introduced to the reactor. HCl gas was added to the reactor periodically to keep the pressure at 1 bar (during the first 60 min). Excess gas was removed after the hydrolysis (1.5 h) to the neutralizing alkaline container with air flow. The pulp was removed from the reactor and washed twice with pure water (2×2 dm³). Yields (56 to 80%) were determined prior to the more detailed analysing of hydrolysed pulp samples.

Hot water extraction of the hydrolysed pulps was conducted with the Soxhlet extraction device (5 g (as dry) of cellulosic material, 6 h reaction time, 500 ml of water). Yields (86 to 97%) were determined prior to the more detailed analysis of extracted pulp samples.

### Example 3: Ball Milling

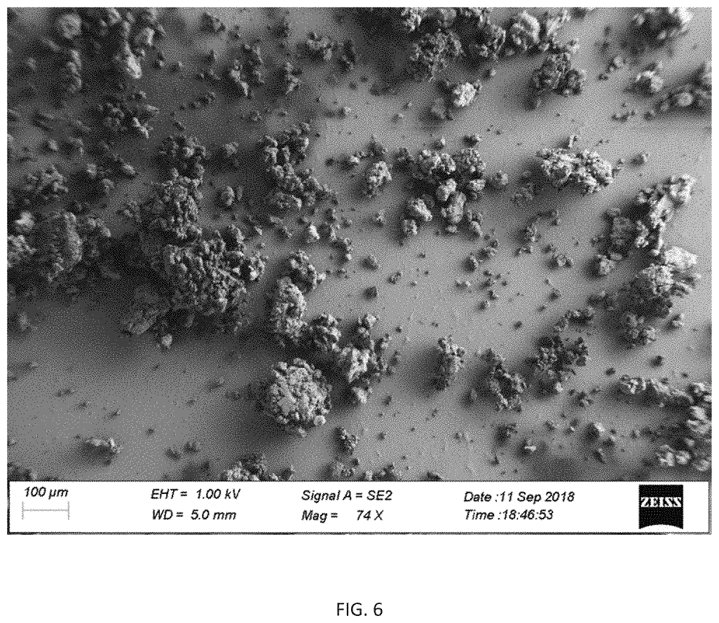

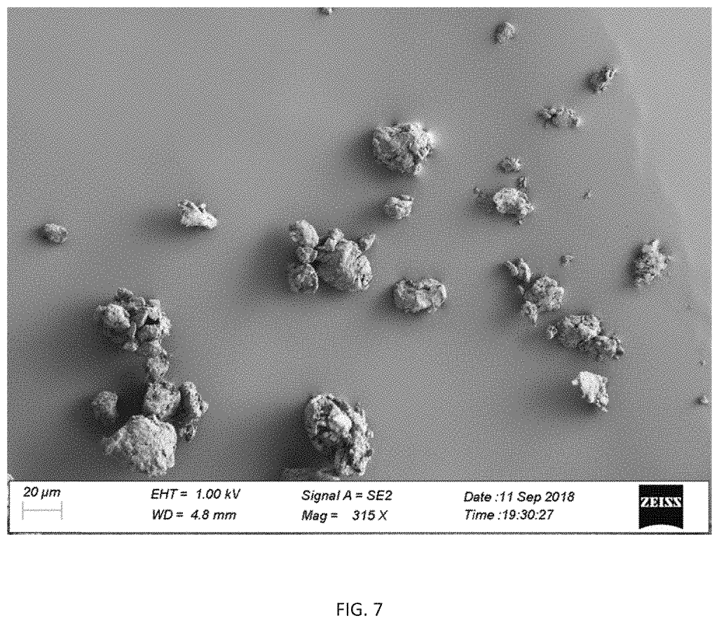

Since acid hydrolysis according to the present invention may be applied for the manufacturing of various hydrolysed cellulosic materials (for example cellulose nanocrystals (CNC), cellulose nanofibrils (CNF) and microcrystalline cellulose (MCC)), we continued the experiments by mincing the hydrolysed pulps with a ball milling technique prior to sonication. The particle size of the products (see FIGS. 6 and 7) was similar to the particle size of commercial MCC products (see for example Thoorens et al. for scanning electron micrograms of commercial Avicel OH-101 and Avicel PH-102).

FIG. 6 shows a SEM image of HCl gas hydrolysed (0.5% NaClO₂ addition) sonicated, and ball-milled dissolving pulp.

FIG. 7 shows a SEM image of HCl gas hydrolysed (3.3% NaClO₂ addition) sonicated, and ball-milled lignin containing pulp.

### Example 4: Potato Fibres

In this example we used potato pulp as the cellulosic starting material.

Commercial potato fibre (Vitacel, J. Rettenmeyer & Sohne, Germany) was alkali extracted with 1 M NaOH (80° C., 2 h, 6% pulp consistency). A major amount of soluble components of the commercial potato fibre (such as amylose, amylopectin, hemicelluloses, protein; see for example Mayer 1998 and Stawski 2008) was dissolved in hot alkali. The yield of thoroughly washed fibrous solids was 23.5%. The alkali extracted potato fibre was mixed thoroughly with a chlorite containing water solution (3.4% NaClO₂ in 0.6 dm³ of aqueous solution). The mixture (potato pulp and NaClO₂ in water) was pressed to the dry matter content of 16%. The chlorite containing pulp (35 g as dry) was added to the glass reactor. 1 bar gas pressure was introduced to the reactor. HCl gas was added to the reactor periodically to keep the pressure at 1 bar (during the first 60 min). The hydrolysis was started in room temperature and no external heating was applied during the course of the hydrolysis reaction. Excess gas was removed after the hydrolysis (which lasted 6 h in total) to the neutralizing alkaline container with air flow. The hydrolysed pulp was removed from the reactor and washed twice with pure water (2×2 dm³). The yield (69.5%) was determined prior to the more detailed analysis of the hydrolysed pulp sample. It was observed that DP had decreased from 3670 to 770.

TEMPO mediated oxidation was performed in a Büchi reactor (volume 1.6 dm³). TEMPO (2 mM) was preactivated with an excess of NaOCl in water and adjustment of pH to 7.5 with H₂SO₄ (see Pääkkönen 2015). The hydrolysed potato fibre pulp was added to the reactor with water (total volume 1.2 dm³). 0.8 mmol NaBr was added to the solution. TEMPO-mediated oxidation was conducted in room temperature with continuous mixing. Addition of NaOCl was 7 mmol/g potato fibre. 1 M NaOH was used to adjust the pH to a value in the range 8 to 10 until all NaOCl was consumed. The oxidised potato fiber was purified with centrifuge (3×4700 rpm, 75 min, Thermo Scientific SL 40 FR). The oxidized fiber, which was turned to gel form, was analysed. The yield and the carboxylate content of the TEMPO-oxidized potato fibre were 95% and 1.1 mmol COOH/g fibre, respectively.

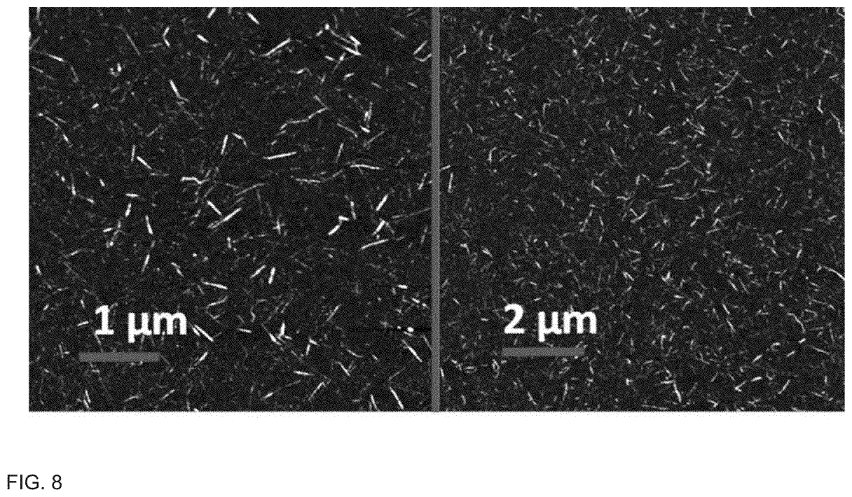

Finally, the oxidized potato fibre gel was sonicated prior to AFM imaging of the formed carboxylated CNCs (see FIG. 8).

FIG. 8 shows AFM images of HCl/NaClO₂ hydrolysed (100 kPa, 6 h, 3.4% NaClO₂) TEMPO-oxidized and sonicated (60% amplitude, 45 seconds) potato fibre CNCs.

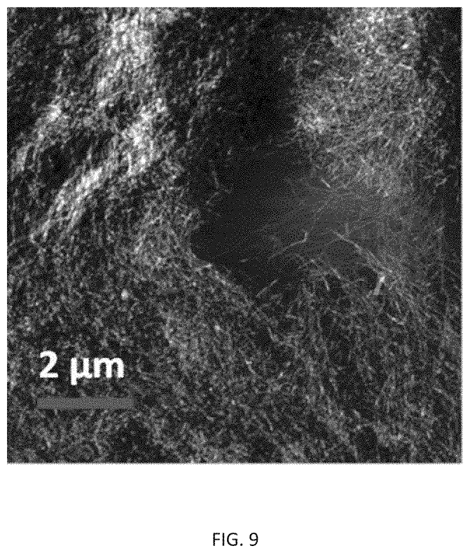

Moreover, formation of nanofibrils was observed by AFM imaging for the oxidized potato fibre gel without sonication (see FIG. 9).

FIG. 9 shows an AFM image of HCl/NaClO₂ hydrolysed (100 kPa, 6 h, 3.4% NaClO₂) TEMPO-oxidized potato fibre nanofibrils.

As a conclusion, HCl/NaClO₂ hydrolysis combined with subsequent TEMPO-mediated oxidation of potato fibre can be applied to produce carboxylated cellulose nanofibrils and carboxylated cellulose nanocrystals (CNCs).

Another sample of potato fibre was alkali extracted and HCl/NaClO₂ hydrolysed as described above but with a shorter hydrolysis reaction time of 4 hours. The resulting yield and DP were 67.4% and 781, respectively. The sample was sonicated with and without pre-treatment (fluidisation with Microfluidics M110P, a chamber pair with diameters 200 and 100 μm at a constant pressure of 1000 bar) prior to the sonication.

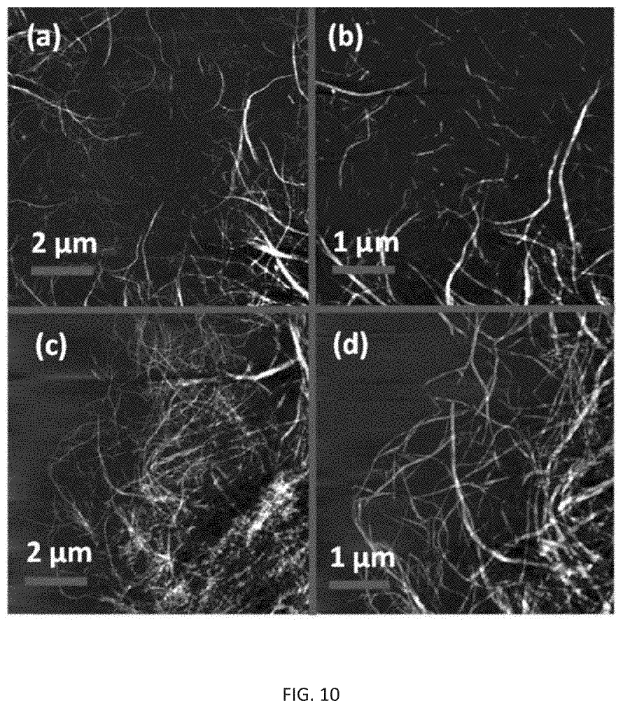

AFM images of the formed cellulose nanofibrils indicated that fluidisation was not necessary in order to obtain nanofibrils (see FIG. 10).

FIGS. 10(a) to 10(d) show AFM images of HCl/NaClO₂ hydrolysed (100 kPa, 4 h, 3.5% NaClO₂) and sonicated potato fibre fibrils. In FIGS. 10(a) and 10(b) the potato fibres had been fluidized (1 pass) prior to the sonication.

### Example 5

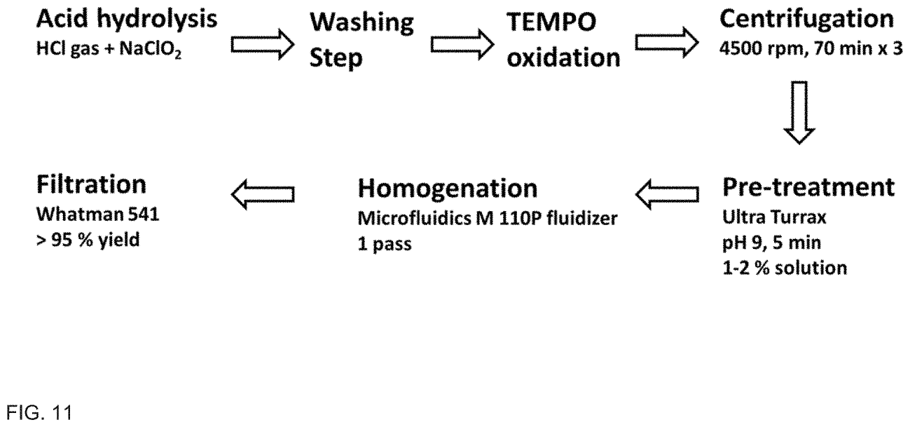

FIG. 11 shows the steps of a process for manufacturing carboxylated CNCs according to an embodiment of the present invention.

In the first step, a cellulosic starting material is hydrolysed by using HCl gas and NaClO₂. Thereafter, the hydrolysed product is washed. TEMPO oxidation is carried out next, and in this step the product becomes functionalized by carboxylate groups. The product is subsequently centrifuged (4500 rpm, 70 min×3), pre-treated (Ultra Turrax, pH 9, 5 min, 1 to 2% solution), homogenized (Microfuidics M110P fluidizer, 1 pass) and filtrated (Whatman 541). As a result, carboxylated CNCs are obtained. The yield of the filtration step is >95% and the yield of the whole manufacturing process is >75%.

It is to be understood that the embodiments of the invention disclosed are not limited to the particular structures, process steps, or materials disclosed herein, but are extended to equivalents thereof as would be recognized by those ordinarily skilled in the relevant arts. It should also be understood that terminology employed herein is used for the purpose of describing particular embodiments only and is not intended to be limiting.

Reference throughout this specification to “one embodiment” or “an embodiment” means that a particular feature, structure, or characteristic described in connection with the embodiment is included in at least one embodiment of the present invention. Thus, appearances of the phrases “in one embodiment” or “in an embodiment” in various places throughout this specification are not necessarily all referring to the same embodiment.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. In addition, various embodiments and example of the present invention may be referred to herein along with alternatives for the various components thereof. It is understood that such embodiments, examples, and alternatives are not to be construed as de facto equivalents of one another, but are to be considered as separate and autonomous representations of the present invention.

Furthermore, the described features, structures, or characteristics may be combined in any suitable manner in one or more embodiments. In the following description, numerous specific details are provided, such as examples of lengths, widths, shapes, etc., to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

The verbs “to comprise” and “to include” are used in this document as open limitations that neither exclude nor require the existence of also un-recited features. The features recited in depending claims are mutually freely combinable unless otherwise explicitly stated. Furthermore, it is to be understood that the use of “a” or “an”, i.e. a singular form, throughout this document does not exclude a plurality.

### INDUSTRIAL APPLICABILITY

The present invention is industrially applicable at least in the manufacturing of cellulosic nanomaterials.

### ACRONYMS LIST

MCC microcrystalline cellulose
CNC cellulose nanocrystals
CNF cellulose nanofibrils
DP degree of polymerisation
AFM atomic force microscopy
SEM scanning electron microscopy

### REFERENCE SIGNS LIST

1 vacuum valve
2 flush line valve
3 bypass valve
4 compressed air valve
5 HCl gas valve
6 to 9 control valves
10 HCl gas bottle main valve
11 vacuum inducing means
12 gas release valve
13 pressure transmitter
14 sample reactor
15 compressed air
16 HCl gas bottle

### CITATION LIST

### Non Patent Literature

Kontturi, E.; Meriluoto, A.; Penttila, P. A.; Baccile, N.; Malho, J.; Potthast, A.; Rosenau, T.; Ruokolainen, J.; Serimaa, R.; Laine, J.; Sixta, H. Degradation and Crystallization of Cellulose in Hydrogen Chloride Vapor for High-Yield Isolation of Cellulose Nanocrystals. Angew. Chem., Int. Ed. 2016, 55, 14455-14458.
Pääkkönen, T., Spiliopoulos, P., Knuts, A., Nieminen, K., Johansson, L-S., Enqvist, E. and Kontturi, E., From vapour to gas: optimising cellulose degradation with gaseous HCl. Reaction Chemistry & Engineering 2018, 3:312-318.

Thoorens, G., Krier, F., Leclercq. B., Carlin, B. and Evrard, B. Microcrystalline cellulose, a direct compression binder in a quality by design environment—A review. International Journal of Pharmaceutics 473: 64-72.
F. Mayer, Polym. Degrad. Stab., 1998, 59, 231-235.
D. Stawski, Food Chemistry, 2008, 110, 777-781.
T. Pääkkönen, C. Bertinetto, R. Pönni, G. Tummala, M. Nuopponen and M. Vuorinen, Applied Catalysis A, 2015, 505, 532-538.
T. Pääkkönen et al., Sustainable High Yield Route to Cellulose Nanocrystals from Bacterial Cellulose, ACS Sustainable Chem. Eng. 2019, 7, 14384-14388.
Zandvoort, I. van., Towards the Valorization of Humin By-products: Characterization, Solubilization and Catalysis., Diss., Utrecht University, 2015.
A. K. Horvath et al. J. Phys. Chem. A, 2003, Vol. 107, No. 36, 6966-6973.

1. A method of preparing a hydrolysed cellulosic material, comprising:
preparing a mixture comprising a cellulosic material and a chlorite salt-containing water solution; and
acidifying said mixture.

2. The method according to claim 1, wherein:
the cellulosic material is a lignocellulosic fibrous material.

3. The method according to claim 1, wherein:
the cellulosic material comprises a plant-based pulp.

4. The method according to claim 1, wherein:
the dry matter content of the cellulosic material, before adding the chlorite salt, is less than 80%;
the added chlorite solution and the cellulosic material are mixed to obtain a dispersion; and
in the mixture to be acidified, the concentration of the chlorite salt is at least 0.5%.

5. The method according to claim 1, wherein:
the cellulosic starting material is a lignin-containing cellulosic material that comprises at least 5% lignin.

6. The method according to claim 1, wherein:
the chlorite salt is an aqueous solution of NaClO₂.

7. The method according to claim 1, wherein:
the concentration of the chlorite salt during said acidifying step is at least 0.1%.

8. The method according to claim 1, wherein:
the concentration of the chlorite salt during said acidifying step is 0.5 to 3.99%.

9. The method according to claim 1, wherein:
said acidifying is carried out by bringing said aqueous mixture in contact with a gaseous pressurized acid; and
whereby the pH becomes lowered to a value below 0.5.

10. The method according to claim 1, wherein:
said acidifying is carried out by bringing said aqueous mixture in contact with a gaseous pressurized hydrogen halide.

11. The method according to claim 1, wherein:
the gas pressure during said acidifying step is at least 0.1 bar.

12. The method according to claim 9, wherein:
the gaseous pressurized acid is added to the mixture periodically to keep the pressure above 1 bar.

13. The method according to claim 1, wherein:
the temperature during said acidifying step is 10 to 100° C.

14. (canceled)

15. A method of preparing a hydrolysed cellulosic material, comprising:
providing a cellulosic raw material comprising at least 20% water;
producing chlorous acid in said cellulosic raw material;
allowing said cellulosic raw material and said chlorous acid to react with each other; and
as a result, obtaining a hydrolysed cellulosic material.

16. The method according to claim 15, wherein said producing step comprises:
adding NaClO₂ to said cellulosic raw material and mixing;
acidifying the mixture of said cellulosic raw material and said NaClO₂ by pressurized HCl gas; and
as a result, producing chlorous acid from NaClO₂ in the acidic conditions.

17. The method according to claim 16, wherein:
NaClO₂ is added to provide a concentration of 0.5 to 13.4%; and
the applied gas pressure is at least 1 bar.

18-21. (canceled)

22. A hydrolysed cellulosic material obtained by the method according to claim 15.

23. (canceled)

24. The hydrolysed cellulosic material according to claim 22, comprising less than 5% humin compounds.

25. The hydrolysed cellulosic material according to claim 22, obtained from unbleached kraft pulp, wherein the kappa number of the hydrolysed cellulosic material is less 50.

26. The hydrolysed cellulosic material according to claim 22, wherein the degree of polymerisation of the hydrolysed cellulosic material is less than 800 and the ISO brightness of the hydrolysed cellulosic material is at least 50.

27-28. (canceled)
